(19) United States
(12) Patent Application Publication
(10) Pub. No.: US 2025/0127238 A1
(43) Pub. Date: Apr. 24, 2025

(54) AEROSOL GENERATION APPARATUS AND CONTROL METHOD THEREFOR

(71) Applicant: SHENZHEN FIRST UNION TECHNOLOGY CO., LTD., Shenzhen, Guangdong Province (CN)

(72) Inventors: Guangping CAO, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/695,834

(22) PCT Filed: Sep. 29, 2022
(86) PCT No.: PCT/CN2022/122825

§ 371 Date: Mar. 27, 2024

(30) Foreign Application Priority Data
Sep. 30, 2021 (CN) 202111160239.1

(51) Int. Cl. A24F 40/57; A24F 40/46; A24F 40/53

(52) U.S. Cl. CPC A24F 40/57; A24F 40/46; A24F 40/53

(57) ABSTRACT

An aerosol generation apparatus and a control method therefor are provided. The method includes: controlling a power source to output power to a heater, so that the heater is within a desired temperature range or is maintained at a target temperature; and controlling the power source to output the power to the heater based on at least one predetermined value or an electric power parameter within a predetermined range during a period in which the heater is within the desired temperature range or is maintained at the target temperature, to adjust a decibel value of noise generated by an aerosol generation apparatus. The power source is controlled to output the power to the heater based on the at least one predetermined value or the electric power parameter within the predetermined range, to adjust the decibel value of the noise generated by the aerosol generation apparatus.

### TECHNICAL FIELD

This application relates to the field of cigarette device technologies, and in particular, to an aerosol generation apparatus and a control method therefor.

### BACKGROUND

During use of articles such as cigarettes or cigars, tobaccos are burnt to generate tobacco smoke. An attempt has been made to provide substitutes for these tobacco-burning articles by producing products that release compounds without burning. An example of the products is a heat-not-burn product, also referred to as a tobacco heating product, or a tobacco heating device, or an aerosol generation apparatus. The product or the device releases compounds by heating materials rather than burning materials. The materials may be, for example, tobacco, or another non-tobacco product, or a combination thereof, such as a blended mixture that may or may not include nicotine.

After a temperature of a heater rises to a preset temperature, an existing aerosol generation apparatus may be maintained at the preset temperature for a period of time during preheating, and then enters an inhalation stage. A problem of the apparatus is that mechanical vibrations may occur in the inhalation stage, and then noise is generated, which causes poor user experience.

### SUMMARY

This application provides an aerosol generation apparatus and a control method therefor, which are intended to resolve a problem of noise in an existing aerosol generation apparatus.

According to a first aspect, an embodiment of this application provides a control method for an aerosol generation apparatus. The aerosol generation apparatus includes a heater configured to heat an aerosol-forming substrate to generate an aerosol and a power source. The method includes: controlling the power source to output power to the heater, so that the heater is within a desired temperature range or is maintained at a target temperature; and controlling the power source to output the power to the heater based on at least one predetermined value or an electric power parameter within a predetermined range during a period in which the heater is within the desired temperature range or is maintained at the target temperature, to adjust a decibel value of noise generated by the aerosol generation apparatus.

In an example, the electric power parameter includes at least one of a current, a voltage, or a frequency, and/or a parameter derived based on at least one of the current, the voltage, or the frequency.

In an example, the method includes: controlling the power source to output the power to the heater based on a variable electric power parameter, and adjusting the decibel value of the noise by limiting a variation of the electric power parameter.

In an example, the variation of the electric power parameter includes a variation of a current or a voltage. The method further includes: controlling the variation of the current or the voltage to limit the decibel value of the noise to below a reference decibel value.

In an example, the variation of the current is controlled to be in a range of 0 A to 5 A, or in a range of 0 A to 4 A, or in a range of 0 A to 3 A, or in a range of 0 A to 2 A, or in a range of 0 A to 1 A, or in a range of 0 A to 0.5 A, or in a range of 0 A to 0.2 A.

In an example, the method includes: controlling the power source to alternately output the power to the heater based on a first electric power parameter and a second electric power parameter less than the first electric power parameter, and limiting a difference between the first electric power parameter and the second electric power parameter not to exceed a preset threshold.

In an example, an alternating frequency of the first electric power parameter and the second electric power parameter is limited to adjust the decibel value of the noise.

In an example, the first electric power parameter and the second electric power parameter each include a voltage, and a voltage value of the second electric power parameter is equal to zero.

In an example, a real-time temperature of the heater is monitored, and a voltage provided to the heater by the power source is controlled based on a temperature value.

In an example, the aerosol generation apparatus further includes a voltage regulating circuit connected to the power source. The method further includes: controlling the voltage regulating circuit to output different voltages to the heater.

In an example, the voltage regulating circuit includes a switch transistor. The method further includes: controlling a duty cycle and/or a switching frequency of the switch transistor to output different voltages.

In an example, the method further includes: controlling the power source to alternately output power of at least two different magnitudes to the heater, and limiting a variation frequency of the power of at least two different magnitudes to adjust the decibel value of the noise generated by the aerosol generation apparatus.

In an example, the variation frequency of the power of at least two different magnitudes is limited to be in a range of 0.05 Hz to 10 Hz, or in a range of 0.05 Hz to 5 Hz, or in a range of 0.05 Hz to 2 Hz, or in a range of 0.05 Hz to 1 Hz, or in a range of 0.05 Hz to 0.8 Hz, or in a range of 0.05 Hz to 0.5 Hz, or in a range of 0.1 Hz to 0.5 Hz.

In an example, the aerosol generation apparatus further includes a switch circuit. The method further includes: controlling a switching frequency of the switch circuit to adjust a frequency outputted by variation power of the power source.

According to a second aspect, an embodiment of this application further provides a control method for an aerosol generation apparatus. The aerosol generation apparatus includes a heater configured to heat an aerosol-forming substrate to generate an aerosol and a power source. The method includes: controlling the power source to output power to the heater, so that the heater is within a desired temperature range or is maintained at a target temperature; and controlling, during a period in which the heater is within the desired temperature range or is maintained at the target temperature, the power source to intermittently output the power to the heater, and limiting a frequency of an action of outputting the power to adjust a decibel value of noise generated by the aerosol generation apparatus.

According to a third aspect, an embodiment of this application further provides an aerosol generation apparatus, including: a power source; a heater, configured to heat an aerosol-forming substrate to generate an aerosol; and a controller, configured to: control the power source to output power to the heater, so that the heater is within a desired temperature range or is maintained at a target temperature; and control the power source to output the power to the heater based on at least one predetermined value or an electric power parameter within a predetermined range during a period in which the heater is within the desired temperature range or is maintained at the target temperature, to adjust a decibel value of noise generated by the aerosol generation apparatus.

In an example, the aerosol generation apparatus further includes a voltage regulating circuit. The voltage regulating circuit is configured to receive control from the controller to adjust a voltage supplied to the heater.

In an example, the voltage regulating circuit includes a boost circuit and/or a buck circuit.

In an example, the voltage regulating circuit includes at least one of a BUCK conversion circuit, a BOOST conversion circuit, a BUCK-BOOST conversion circuit, a CUK conversion circuit, a ZETA conversion circuit, or a SEPIC conversion circuit.

In an example, the heater includes a resistive heating element connected to the power source, and the controller is configured to adjust a decibel value of noise of the heater when a varying current flows through the resistive heating element.

In an example, the heater includes an induction coil connected to the power source and an inductive heater electromagnetically coupled to the induction coil, and the controller is configured to adjust a decibel value of noise of the induction coil when a varying current flows through the induction coil.

In an example, the heater is constructed as an elongated heater to be inserted into the aerosol-forming substrate for heating.

In an example, the aerosol generation apparatus further includes a switch circuit. The switch circuit is configured to receive control from the controller to electrically connect a battery core to the heater or disconnect the battery core from the heater.

In an example, the switch circuit includes a first switch transistor and a second switch transistor. The first switch transistor and the second switch transistor each include an input connection terminal, an output connection terminal, and a control terminal. The control terminal of the first switch transistor is configured to receive control from the controller, the input connection terminal of the first switch transistor is electrically connected to the control terminal of the second switch transistor, and the output connection terminal of the first switch transistor is grounded. The input connection terminal of the second switch transistor is electrically connected to the battery core, and the output connection terminal of the second switch transistor is electrically connected to the heater.

According to the control method for an aerosol generation apparatus provided in this application, the power source is controlled to output the power to the heater based on the at least one predetermined value or the electric power parameter within the predetermined range, to adjust the decibel value of the noise generated by the aerosol generation apparatus, so that a problem of poor user experience caused by excessive noise is avoided, thereby improving user experience.

### BRIEF DESCRIPTION OF THE DRAWINGS

One or more embodiments are exemplarily described with reference to figures in accompanying drawings corresponding to the embodiments, and the exemplary descriptions do not constitute a limitation on the embodiments. Elements in the accompanying drawings that have same reference numerals are represented as similar elements, and unless otherwise particularly stated, the figures in the accompanying drawings are not drawn to scale.

FIG. 1 is a schematic diagram of a control method for an aerosol generation apparatus according to an implementation of this application.

FIG. 2 is a schematic diagram of an aerosol generation apparatus according to an implementation of this application.

FIG. 3 is a schematic diagram of a temperature curve of a heater according to an implementation of this application.

FIG. 4 is a schematic diagram of a voltage waveform of a heater according to an implementation of this application.

FIG. 5 is a schematic diagram of a voltage regulating circuit according to an implementation of this application.

FIG. 6 is a schematic diagram of another voltage regulating circuit according to an implementation of this application.

FIG. 7 is a schematic diagram of still another voltage regulating circuit according to an implementation of this application.

FIG. 8 is a schematic diagram of still another voltage regulating circuit according to an implementation of this application.

FIG. 9 is a schematic diagram of another aerosol generation apparatus according to an implementation of this application.

FIG. 10 is a schematic diagram of still another aerosol generation apparatus according to an implementation of this application.

FIG. 11 is a schematic diagram of a switch circuit of another aerosol generation apparatus according to an implementation of this application.

FIG. 12 is a schematic diagram of another voltage waveform according to an implementation of this application.

### DETAILED DESCRIPTION

For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When one element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the technical field to which this application belongs. The terms used in this specification of this application are merely intended to describe objectives of the specific implementations, and are not intended to limit this application. A term “and/or” used in this specification includes any or all combinations of one or more related listed items.

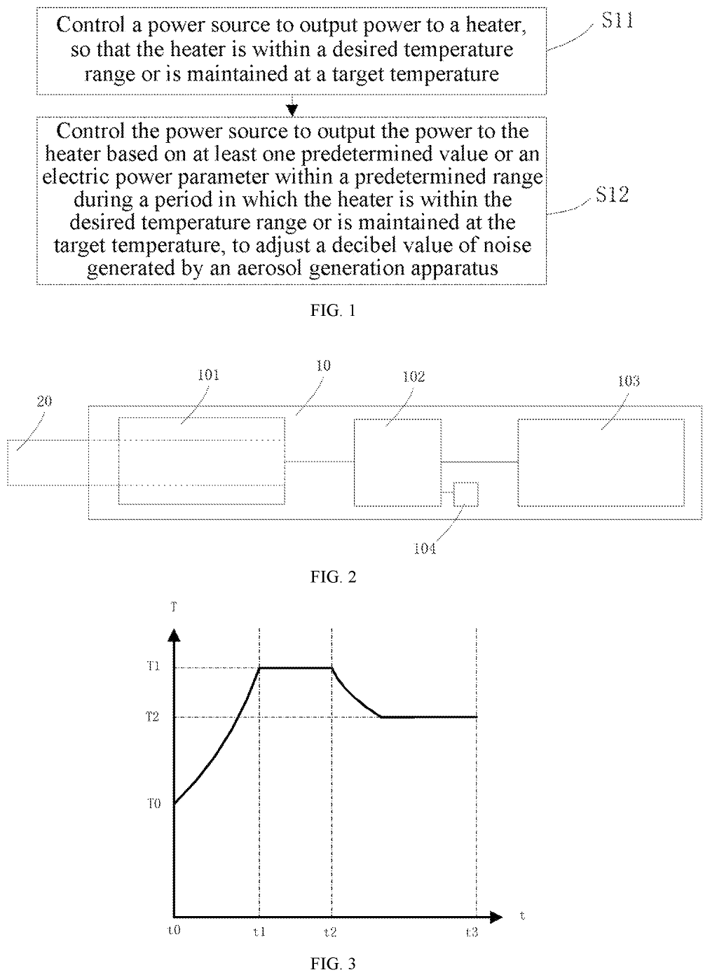

FIG. 1 is a schematic diagram of a control method for an aerosol generation apparatus according to an implementation of this application.

The aerosol generation apparatus includes a heater configured to heat an aerosol-forming substrate to generate an aerosol. The heater may be constructed as a peripheral or circumferential heating structure (the heater surrounds at least part of the aerosol-forming substrate), or may be constructed as a central heating structure (a periphery of the heater is in direct contact with the aerosol-forming substrate). A heating manner may be resistive heating, infrared heating, electromagnetic heating, and the like, which is not limited herein.

The method includes the following steps:

Step S11: Control a power source to output power to the heater, so that the heater is within a desired temperature range or is maintained at a target temperature.

Step S12: Control the power source to output the power to the heater based on at least one predetermined value or an electric power parameter within a predetermined range during a period in which the heater is within the desired temperature range or is maintained at the target temperature, to adjust a decibel value of noise generated by the aerosol generation apparatus.

When the heater is within the desired temperature range or is maintained at the target temperature, a user may inhale the aerosol generated by the aerosol generation apparatus within a preset duration. Generally, the target temperature is in a range of 150° C. to 350° C., or in a range of 150° C. to 300° C., or in a range of 150° C. to 250° C., or in a range of 150° C. to 200° C. The desired temperature range may vary based on the target temperature.

The power source is controlled to output the power to the heater based on the at least one predetermined value or the electric power parameter within the predetermined range, so as to control the decibel value of the noise generated by the aerosol generation apparatus to be within a range acceptable to the user. In an example, the user expects that the decibel value of the noise generated by the aerosol generation apparatus is limited to below a reference decibel value, for example, limited to below a reference decibel value of 45 bB, so that vibration noise generated by the aerosol generation apparatus during inhalation of the user does not affect user experience. In a preferred implementation, for another example, the decibel value of the noise generated by the aerosol generation apparatus is maintained within the following range acceptable to the user: 0 dB to 32 dB, 0 dB to 30 dB, 0 dB to 26 dB, 0 dB to 20 dB, 5 dB to 20 dB, or the like.

The electric power parameter includes at least one of a current, a voltage, or a frequency, and/or a parameter derived based on at least one of the current, the voltage, or the frequency, for example, a variation or a rate of change.

A preferred implementation of this application is described below with reference to FIG. 2 to FIG. 8.

As shown in FIG. 2, an aerosol generation apparatus 10 includes a heater 101, a controller 102, and a battery core 103.

The heater 101 is configured to generate heat based on electric power provided by the battery core 103, to heat a product 20 placed in the aerosol generation apparatus 10, so that an aerosol-forming substrate in the product 20 generates an aerosol for a user to inhale.

In an example of FIG. 2, the heater 101 is constructed as a peripheral or circumferential heating structure (the heater 101 surrounds at least part of the aerosol-forming substrate), and the heating manner may be resistive heating, infrared heating, electromagnetic heating, or the like.

The controller 102 is respectively connected to the heater 101 and the battery core 103, and is configured to control the electric power supplied to the heater 101 by the battery core 103 or output power to the heater 101, and then control a heating temperature of the heater 101, so that the aerosol-forming substrate generates the aerosol.

The controller 102 is further configured to perform a control method for the aerosol generation apparatus 10.

The aerosol generation apparatus 10 may further include a storage medium configured to store a program for performing the control method for the aerosol generation apparatus 10, and the controller 102 may read and execute the program for performing the control method for the aerosol generation apparatus 10 stored in the storage medium, to implement the control method for the aerosol generation apparatus 10. The storage medium may be an independent storage device arranged in the aerosol generation apparatus 10, or may be a storage medium built into the controller 102. The storage medium includes but is not limited to a non-volatile storage medium.

The battery core 103, that is, a power source, is configured to provide electric power to the heater 101 and the controller 102. The battery core 103 may be a rechargeable battery core, or may be a non-rechargeable battery core.

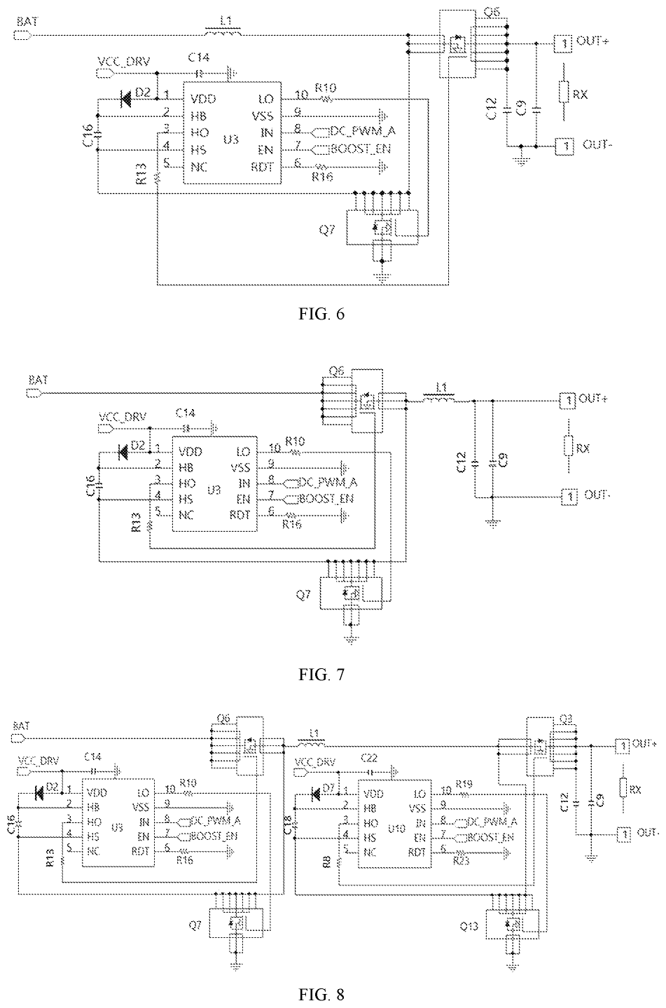

In the example of FIG. 2, the aerosol generation apparatus 10 further includes a voltage regulating circuit 104 coupled between the heater 101 and the battery core 103. The voltage regulating circuit 104 includes a boost circuit and/or a buck circuit, for example, at least one of a BUCK-BOOST conversion circuit shown in FIG. 5 and FIG. 8, a BOOST conversion circuit shown in FIG. 6, a BUCK conversion circuit shown in FIG. 7, a CUK conversion circuit (not shown), a ZETA conversion circuit (not shown), or a SEPIC conversion circuit (not shown).

The voltage regulating circuit 104 includes a switch transistor. A duty cycle and/or a switching frequency of the switch transistor in the voltage regulating circuit 104 is controlled, to adjust a voltage of the electric power signal supplied to the heater 101, so that a variation of a current flowing through the heater 101 is maintained within a preset range, and then a decibel value of noise generated by the aerosol generation apparatus 10 is controlled.

The voltage of the electric power supplied to the heater 101 may be adjusted based on a real-time temperature of the heater 101. The real-time temperature of the heater 101 may be detected through a temperature sensor (not shown in the figure) connected to the controller 102. The temperature sensor includes but is not limited to a thermocouple and a temperature detection module with a temperature coefficient of resistance. In a preferred implementation, the heater 101 may have the temperature coefficient of resistance. The real-time temperature of the heater 101 may be determined by using a resistance value of the heater 101.

In this example, a voltage waveform of the electric power supplied to the heater 101 includes but is not limited to a square wave, a triangular wave, and a sawtooth wave.

FIG. 3 is a schematic diagram of a temperature curve of a heater. An abscissa t of the temperature curve represents a time, and an ordinate T represents a temperature.

At a moment to, an initial temperature of the heater 101 is TO.

In an example of FIG. 3, the initial temperature is greater than an ambient temperature. In another example, the initial temperature may be the ambient temperature.

During a period of time from t0 to t1, the controller 102 controls the electric power of the heater 101 to perform heating at a maximum power or another preset power. For example, the maximum power is 36 W. At the moment t1, the heater 101 reaches a preset temperature T1.

The preset temperature may be an optimal temperature for the aerosol-forming substrate to generate the aerosol. To be specific, the aerosol-forming substrate may provide an amount and a temperature of smoke that is most suitable for the user to inhale and taste better at the temperature. In the implementation of this application, the adopted preset temperature is in a range of 150° C. to 350° C., or in a range of 180° C. to 350° C., or in a range of 220° C. to 350° C., or in a range of 220° C. to 300° C., or in a range of 220° C. to 280° C., 220° C. to 260° C.

During a period of time from t1 to t2, the controller 102 controls the electric power supplied to the heater 101 by the battery core 103, and controls the heater 101 to be maintained at the preset temperature T1 (220° C.) for a period of time (that is, the period of time from t1 to t2). It should be noted that, in another example, it is also feasible that the period of time from t1 to t2 is not set.

At the moment t2, the controller 102 can output a prompt signal for inhaling the aerosol, to prompt the user to inhale. Specifically, a prompt operation may be performed through a prompt apparatus connected to the controller 102 based on the prompt signal for inhaling the aerosol outputted by the controller 102. For example, when the prompt apparatus is a vibration motor, the vibration motor vibrates to prompt the user to inhale the aerosol based on the prompt signal (including a start signal used for controlling operation of the vibration motor) regarding the inhalable aerosol outputted by the controller 102. When the prompt apparatus is an LED light, the LED light is constantly lit or flashes based on the prompt signal regarding the inhalable aerosol outputted by the controller 102, to prompt the user to inhale the inhalable aerosol.

During a period of time from t2 to t3, after outputting the prompt signal regarding the inhalable aerosol, the controller 102 controls the electric power supplied to the heater 101 by the battery core 103 and controls the temperature of the heater 101 to decrease from T1 to a target temperature T2. Then the controller 102 controls the electric power supplied to the heater 101 by the battery core 103, to control the heater 101 to be maintained at the target temperature T2.

A value during the period of time from t2 to t3 may be in a range of 120 seconds to 360 seconds or a length of time during which 6-20 puffs are taken.

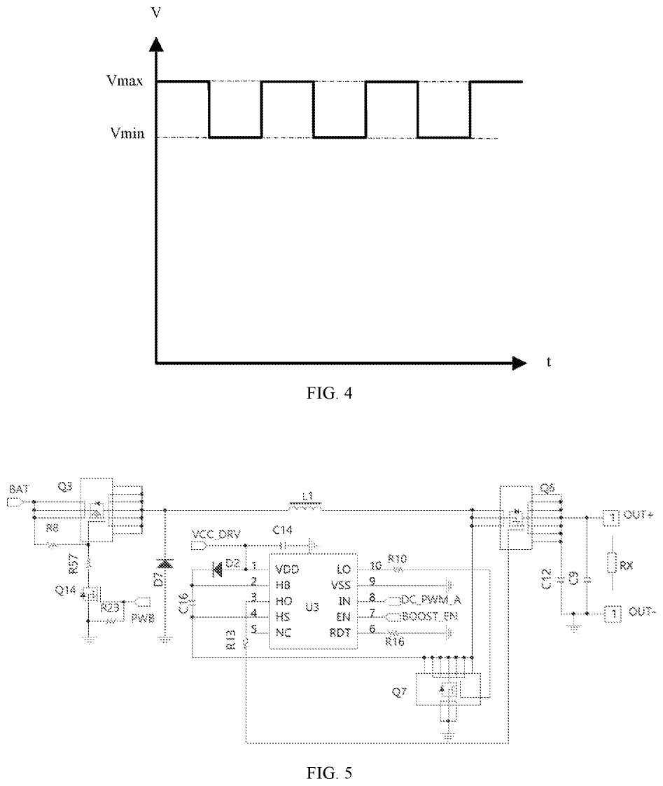

As shown in FIG. 4, during the period of time from t2 to t3, an electric power parameter of the power supplied to the heater 101 includes a first electric power parameter and a second electric power parameter that are alternately provided. In the implementation shown in FIG. 4, the first electric power parameter and the second electric power parameter each include a voltage, and a voltage waveform provided by the power source is a square wave. In the square wave, a voltage provided by the power source includes a first voltage and a second voltage, and the second voltage is less than the first voltage. For example, a first voltage Vmax is a maximum voltage value of the electric power supplied to the heater 101, and a second voltage Vmin is a minimum voltage value of the electric power supplied to the heater 101. To control the decibel value of the noise generated by the aerosol generation apparatus 10 to be within the range acceptable to the user, Vmax and Vmin satisfy the following relationship:

(Vmax−Vmin)/RX=I_{V}, where RX is a resistance value of the heater 101, I_{V} is a current variation of an electric power signal, and a preset range of the current variation is in a range of 0 A to 5 A, or in a range of 0 A to 4 A, or in a range of 0 A to 3 A, or in a range of 0 A to 2 A, or in a range of 0 A to 1 A, or in a range of 0 A to 0.5 A, or in a range of 0 A to 0.2 A. When the resistance value of the heater 101 is constant, a voltage variation of the electric power supplied to the heater 101 is also within a corresponding preset range.

FIG. 5 is a schematic diagram of a specific circuit. An asynchronous buck circuit and a boost circuit are coupled between the battery core 103 (as shown by BAT in the figure) and the heater 101 (the heater 101 is shown by OUT+ and OUT− in the figure).

The period of time from t0 to t1 in FIG. 4 is used as an example. When a switch transistor Q3 is turned on, and the asynchronous buck circuit does not operate, the boost circuit composed of a switch transistor Q7 and a switch transistor Q6 operates, and outputs a direct current voltage higher than a voltage amplitude of the battery core 103, so that the heater 101 reaches the preset temperature T1.

When the heater 101 reaches the preset temperature T1, the switch transistor Q6 may be controlled to be turned on, and the switch transistor Q7 may be controlled to be turned off. To be specific, the boost circuit stops operating. Then a switch transistor Q14 is controlled through the controller 102, so that the switch transistor Q3 outputs a PWM pulse signal, to cause the asynchronous buck circuit composed of the switch transistor Q3, a diode D7, an inductor L1, the switch transistor Q6, and heaters C12 and C9 to operate to decrease the voltage of the electric power applied to the heater 101 and accordingly, the temperature of the heater. When the temperature of the heater 101 decreases from T1 to T2, since the voltage at this moment cannot increase the temperature of the heater 101, the boost circuit needs to be enabled again to increase the temperature of the heater 101 to the set temperature value T2. During the period of time from t2 to t3, the boost circuit and the asynchronous buck circuit alternately operate to control the voltage of the electric power supplied to the heater 101, so that the variation of the current flowing through the heater 101 is maintained within the preset range, so as to limit an amplitude of mechanical vibrations generated in a varying magnetic field environment produced by the heater 101 as a result of a varying current, and then control the decibel value of the noise generated by the aerosol generation apparatus 10.

Noise tests are carried out for different current variations.

Test quantity (Qty): 10.

Test method: An aerosol generation apparatus was arranged at a distance of 10 MM from a noise collector. Noise data was collected in real time for the aerosol generation apparatus in operation in an anechoic measurement laboratory. After a product (a cigarette) is inserted into the aerosol generation apparatus and the aerosol generation apparatus is powered on, an average value of noise is observed in a constant temperature stage (the period of time from t2 to t3).

Test condition: bottom noise in the measurement laboratory is 19 dB.

Test device: A5 audio analyzer.

Determination standards: Environmental noise standards are used as the determination standards, in which an environment with a decibel level between 0 dB and 30 dB is defined as a very quiet environment, an environment with a decibel level between 30 dB and 50 dB is defined as a quiet environment, and an environment with a decibel level between 50 dB and 70 dB is defined as a fairly quiet environment.

### Noise Test Results:

| | | | Test decibel |
|---|---|---|---|
| Current | | | dB (a distance |
| variation | | Human body sensory evaluation | of 10 mm) |
| 5 | A | A slight buzzing sound is audible close to a | 32 |
| | | human ear. | |
| 4 | A | A slightly intermittent buzzing sound is | 30 |
| | | audible close to a human ear. | |
| 3 | A | An intermittent POP sound (blasting noise) | 28 |
| | | is audible close to a human ear. | |
| 2 | A | A slightly intermittent POP sound is | 24 |
| | | audible close to a human ear. | |
| 1.5 | A | A slightly intermittent POP sound is | 21 |
| | | occasionally audible close to a human ear. | |
| 1 | A | Almost no sound is audible close to a | 19 |
| | | human ear. | |
| 0.5 | A | Almost no sound is audible close to a | 19 |
| | | human ear. | |
| 0.2 | A | Almost no sound is audible close to a | 19 |
| | | human ear. | |

It may be seen from the above test results that when the variation of the current flowing through the heater 101 is in a range of 1 A to 5 A, the test decibel is within the range (quiet) acceptable to the user although a buzzing sound is audible. When the variation of the current flowing through the heater 101 is below 1 A, almost no sound is audible close to a human ear, and user experience is the best. With a decrease in the variation of the current flowing through the heater 101, the tested decibel value decreases accordingly.

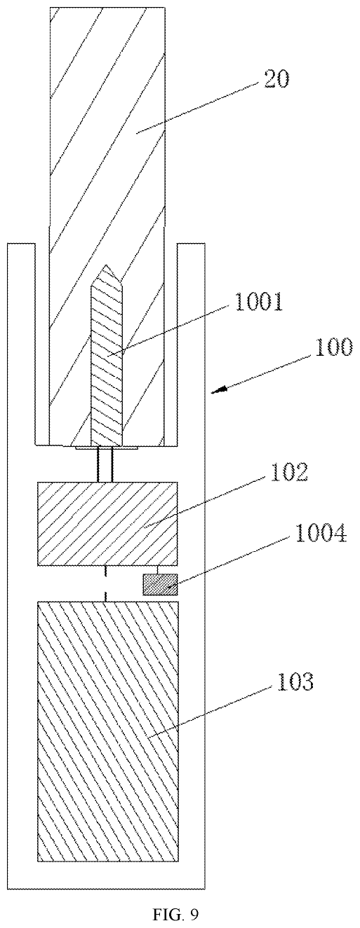

Another preferred implementation of this application is described below with reference to FIG. 9 to FIG. 12.

As shown in FIG. 9, different from the embodiment of FIG. 2, a heater 1001 in an aerosol generation apparatus 100 is constructed as a central heating structure (a periphery of the heater is in direct contact with an aerosol-forming substrate). The heating manner is not limited. A controller 102 and a battery core 103 in the aerosol generation apparatus 100 are similar to those described above.

In an implementation shown in FIG. 9, the heater 1001 is constructed as an elongated heater to be inserted into the aerosol-forming substrate. In an example, the heater 1001 includes an elongated heater base and a resistive heating element bonded to the heater base. The resistive heating element can generate heat when a current flows therethrough. The battery core 103 is connected to the resistive heating element of the heater 1001 through the controller 102. The controller 102 in the aerosol generation apparatus 100 may output power through an appropriate electric power parameter to limit an amplitude or a frequency of mechanical vibrations of the heater 1001 when a varying current flows through the resistive heating element, so that a decibel value of noise of the heater is maintained at a relatively low level. The battery core 103 may be used as a power source.

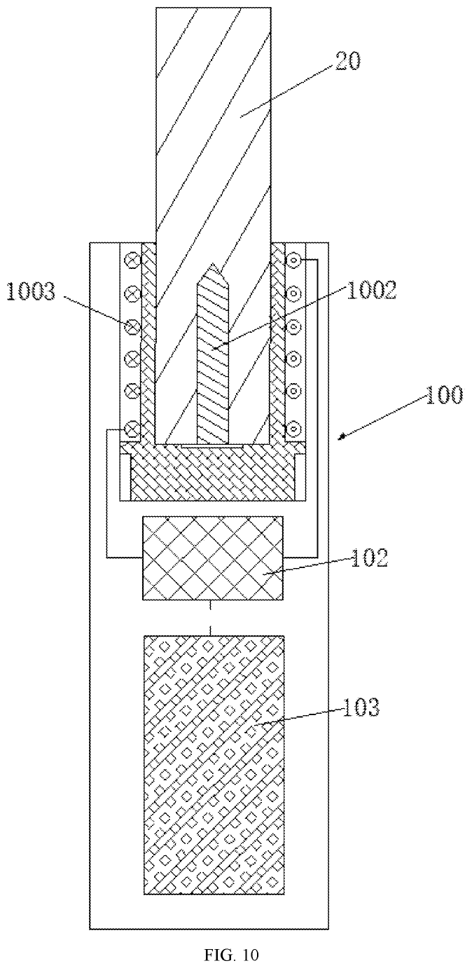

As shown in FIG. 10, in another example, the heater may further include an induction coil 1003 connected to the power source and an inductive heater 1002 electromagnetically coupled to the induction coil 1003. The inductive heater 1002 generates heat in a varying magnetic field generated by the induction coil 1003, to heat the aerosol-forming substrate. The battery core 103 is connected to the induction coil 1003 through the controller 102. The controller 102 in the aerosol generation apparatus can output the power to the induction coil 1003 with the appropriate electric power parameter, for example, provide a varying current to the induction coil at an appropriate frequency, thereby limiting vibrations of the induction coil 1003 and maintaining a decibel value of noise of the induction coil at a relatively low level. The battery core 103 may be used as a power source.

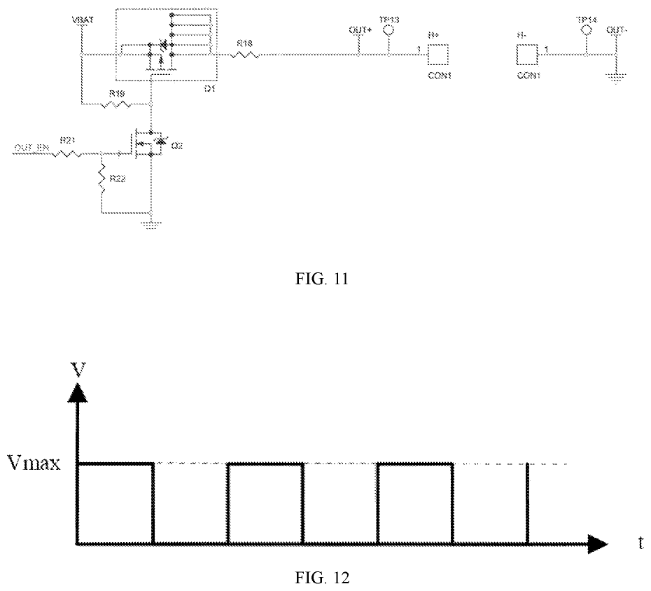

The aerosol generation apparatus 100 further includes a switch circuit 1004 coupled between the heater 1001 and the battery core 103. As shown in FIG. 11, the switch circuit 1004 includes a switch transistor Q2 and a switch transistor Q1. The switch transistor Q2 and the switch transistor Q1 each include an input connection terminal, an output connection terminal, and a control terminal. In this example, the switch transistor Q2 is an NMOS transistor, and the switch transistor Q1 is a PMOS transistor. The input connection terminal of the switch transistor Q2 is a drain, the output connection terminal thereof is a source, and the control terminal thereof is a gate. The input connection terminal of the switch transistor Q1 is a source, the output connection terminal thereof is a drain, and the control terminal thereof is a gate. The control terminal of the switch transistor Q2 is configured to receive control from the controller 102, to electrically connect the battery core 103 to the heater 1001 or disconnect the battery core from the heater. The input connection terminal of the switch transistor Q2 is electrically connected to the control terminal of the switch transistor Q1, and the output connection terminal of the switch transistor Q2 is grounded. The input connection terminal of the switch transistor Q1 is electrically connected to the battery core, and the output connection terminal of the switch transistor Q1 is electrically connected to the heater 101.

The schematic diagram of the temperature curve of the heater shown in FIG. 3 is still used as an example. During the period of time from t2 to t3, output power with different magnitudes may be provided, to maintain the heater at a target temperature. The controller further controls a decibel value of noise generated by the aerosol generation apparatus 100 by maintaining a frequency of the electric power parameter such as a voltage related to the power provided to the heater at a predetermined value or within an appropriate range. In a feasible implementation, a switching frequency of an intermittent action of the switch transistor Q2 is controlled, a variation frequency of an output voltage may be maintained within an appropriate range. In a preferred solution, the foregoing frequency is in a range of 0.05 Hz to 10 Hz, or in a range of 0.05 Hz to 5 Hz, or in a range of 0.05 Hz to 2 Hz, or in a range of 0.05 Hz to 1 Hz, or in a range of 0.05 Hz to 0.8 Hz, or in a range of 0.05 Hz to 0.5 Hz, or in a range of 0.1 Hz to 0.5 Hz.

In an example, the controller controls the power source to alternately provide at least two different voltages to the heater. One of the voltages is equal to zero. To be specific, the power source intermittently provides the voltage to the heater. In a feasible implementation, during the period of time from t2 to t3 shown in FIG. 12, a voltage waveform of a voltage supplied to the heater 101 by the power source is a square wave. In the square wave, Vmax is a maximum voltage value of the electric power supplied to the heater 101, and a minimum voltage value of the electric power supplied to the heater 101 is zero.

A noise test is carried out for different switching frequencies:

Test quantity (Qty): 10.

Test method: An aerosol generation apparatus was arranged at a distance of 10 mm from a noise collector. Noise data was collected in real time in an anechoic measurement laboratory. After a product (a cigarette) is inserted and the aerosol generation apparatus is powered on, an average value of noise in a constant temperature stage (the period of time from t2 to t3) is observed.

Test condition: bottom noise in the measurement laboratory is 19 dB.

Test device: A5 audio analyzer.

Determination standards: Environmental noise standards are used as the determination standards, in which an environment with a decibel level between 0 dB and 30 dB is defined as a very quiet environment, an environment with a decibel level between 30 dB and 50 dB is defined as a quiet environment, and an environment with a decibel level between 50 dB and 70 dB is defined as a fairly quiet environment.

### Noise Test Results:

| Switching | | |
|---|---|---|
| frequency | | Test decibel dB |
| (Hz) | Human body sensory evaluation | (a distance of 10 mm) |
| 10 | A clear POP sound is audible | 30 |
| | close to a human ear. | |
| 5 | A clear POP sound is audible | 26 |
| | close to a human ear. | |
| 2 | A slight POP sound is audible | 23 |
| | close to a human ear. | |
| 1 | A slight POP sound is audible | 22 |
| | close to a human ear. | |
| 0.8 | A slight POP sound is audible | 21 |
| | close to a human ear. | |
| 0.5 | No sound is audible close to a | 19 |
| | human ear. | |
| 0.1 | No sound is audible close to a | 19 |
| | human ear. | |

It may be seen from the above test results that vibration noise generated by the heater may be limited desirably when the variation frequency of different power provided to the heater is relatively low. In a preferred solution, when a switching frequency of the switch transistor Q2 is in a range of 0.5 Hz to 10 Hz, the test decibel is within the range (very quiet) acceptable to the user although a sound is audible. When the switching frequency of the switch transistor Q2 is below 0.5 Hz, almost no sound is audible close to the human ear, and user experience is the best. With a decrease in the switching frequency of the switch transistor Q2, the tested decibel value decreases accordingly. In an implementation, the controller may be configured to maintain the variation frequency of different power provided to the heater to at a specific value in the range of 0.5 Hz to 10 Hz or vary within the range.

It should be noted that, the frequency control manner of an electric power signal in FIG. 9 to FIG. 12 is also applicable to the examples in FIG. 2 to FIG. 8. In an example, the decibel value of the noise generated by the aerosol generation apparatus 10 is controlled by simultaneously controlling the variation of the current flowing through the heater 101 and the frequency of the electric power signal intermittently provided.

The apparatus embodiments described above are merely examples. The units described as separate components may or may not be physically separate, and the components displayed as units may or may not be physical units, which may be located in one place, or may be distributed on a plurality of network units. Some or all of the modules may be selected according to actual needs to achieve the objectives of the solutions of the embodiments.

Through the description of the above implementations, a person of ordinary skill in the art may clearly understand that the implementations may be implemented by software in combination with a universal hardware platform. Certainly, the implementations may alternatively be implemented by hardware. A person of ordinary skill in the art may understand that all or some of processes of the methods in the above embodiments may be implemented by instructing relevant hardware through a computer program. The program may be stored in a computer-readable storage medium. When the program is executed, the processes of the embodiments of the methods described above may be performed. The storage medium may be a magnetic disk, an optical disc, a read-only memory (ROM), a random access memory RAM, or the like.

Finally, it should be noted that, the above embodiments are merely used for describing the technical solutions of this application, but are not intended to limit this application. Under the idea of this application, the technical features in the above embodiments or different embodiments may also be combined, the steps may be performed in any order, and there are many other variations of different aspects of this application as described above. For brevity, the variations are not provided in detail. Although this application is described in detail with reference to the above embodiments, it is to be appreciated by a person skilled in the art that, modifications may still be made to the technical solutions described in the above embodiments, or equivalent replacements may be made for some of the technical features. However, these modifications or replacements do not cause the essence of corresponding technical solutions to depart from the scope of the technical solutions in the embodiments of this application.

1. A control method for an aerosol generation apparatus, wherein the aerosol generation apparatus comprises a heater configured to heat an aerosol-forming substrate to generate an aerosol and a power source, and the method comprises:
controlling the power source to output power to the heater, so that the heater is within a desired temperature range or is maintained at a target temperature; and
controlling the power source to output the power to the heater based on at least one predetermined value or an electric power parameter within a predetermined range during a period in which the heater is within the desired temperature range or is maintained at the target temperature, to adjust a decibel value of noise generated by the aerosol generation apparatus.

2. The method according to claim 1, wherein the electric power parameter comprises at least one of a current, a voltage, or a frequency, and/or a parameter derived based on at least one of the current, the voltage, or the frequency.

3. The method according to claim 1, comprising: controlling the power source to output the power to the heater based on a variable electric power parameter, and adjusting the decibel value of the noise by limiting a variation of the electric power parameter.

4. The method according to claim 3, wherein the variation of the electric power parameter comprises a variation of a current or a voltage; and
the method further comprises:
controlling the variation of the current or the voltage to limit the decibel value of the noise to below a reference decibel value.

5. The method according to claim 4, wherein the variation of the current is controlled to be in a range of 0 A to 5 A, or in a range of 0 A to 4 A, or in a range of 0 A to 3 A, or in a range of 0 A to 2 A, or in a range of 0 A to 1 A, or in a range of 0 A to 0.5 A, or in a range of 0 A to 0.2 A.

6. The method according to claim 3, comprising: controlling the power source to alternately output the power to the heater based on a first electric power parameter and a second electric power parameter less than the first electric power parameter, and limiting a difference between the first electric power parameter and the second electric power parameter not to exceed a preset threshold.

7. The method according to claim 6, wherein the decibel value of the noise is adjusted by limiting an alternating frequency of the first electric power parameter and the second electric power parameter.

8. The method according to claim 6, wherein the first electric power parameter and the second electric power parameter each comprise a voltage, and a voltage value of the second electric power parameter is equal to zero.

9. The method according to claim 1, wherein a real-time temperature of the heater is monitored, and a voltage provided to the heater by the power source is controlled based on a temperature value.

10. The method according to claim 9, wherein the aerosol generation apparatus further comprises a voltage regulating circuit connected to the power source; and
the method further comprises:
controlling the voltage regulating circuit to output different voltages to the heater.

11. The method according to claim 10, wherein the voltage regulating circuit comprises a switch transistor; and
the method further comprises:
controlling a duty cycle and/or a switching frequency of the switch transistor to output different voltages.

12. The method according to claim 1, further comprising:
controlling the power source to alternately output power of at least two different magnitudes to the heater, and limiting a variation frequency of the power of at least two different magnitudes to adjust the decibel value of the noise generated by the aerosol generation apparatus.

13. The method according to claim 12, wherein the variation frequency of the power of at least two different magnitudes is limited to be in a range of 0.05 Hz to 10 Hz, or in a range of 0.05 Hz to 5 Hz, or in a range of 0.05 Hz to 2 Hz, or in a range of 0.05 Hz to 1 Hz, or in a range of 0.05 Hz to 0.8 Hz, or in a range of 0.05 Hz to 0.5 Hz, or in a range of 0.1 Hz to 0.5 Hz.

14. The method according to claim 12, wherein the aerosol generation apparatus further comprises a switch circuit; and
the method further comprises:
controlling a switching frequency of the switch circuit to adjust a frequency outputted by variation power of the power source.

15. A control method for an aerosol generation apparatus, wherein the aerosol generation apparatus comprises a heater configured to heat an aerosol-forming substrate to generate an aerosol and a power source, and the method comprises:
controlling the power source to output power to the heater, so that the heater is within a desired temperature range or is maintained at a target temperature; and
controlling, during a period in which the heater is within the desired temperature range or is maintained at the target temperature, the power source to intermittently output the power to the heater, and limiting a frequency of an action of outputting the power to adjust a decibel value of noise generated by the aerosol generation apparatus.

16. An aerosol generation apparatus, comprising:
a power source;
a heater, configured to heat an aerosol-forming substrate to generate an aerosol; and
a controller, configured to: control the power source to output power to the heater, so that the heater is within a desired temperature range or is maintained at a target temperature; and control the power source to output the power to the heater based on at least one predetermined value or an electric power parameter within a predetermined range during a period in which the heater is within the desired temperature range or is maintained at the target temperature, to adjust a decibel value of noise generated by the aerosol generation apparatus.

17. The aerosol generation apparatus according to claim 16, further comprising a voltage regulating circuit, wherein
the voltage regulating circuit is configured to receive control from the controller to adjust a voltage supplied to the heater.

18. (canceled)

19. (canceled)

20. The aerosol generation apparatus according to claim 16, wherein the heater comprises a resistive heating element connected to the power source, and the controller is configured to adjust a decibel value of noise of the heater when a varying current flows through the resistive heating element.

21. The aerosol generation apparatus according to claim 16, wherein the heater comprises an induction coil connected to the power source and an inductive heater electromagnetically coupled to the induction coil, and the controller is configured to adjust a decibel value of noise of the induction coil when a varying current flows through the induction coil.

22. The aerosol generation apparatus according to claim 16, wherein the heater is constructed as an elongated heater to be inserted into the aerosol-forming substrate for heating.

23. (canceled)

24. (canceled)
